(19) United States
(12) Patent Application Publication
(10) Pub. No.: US 2026/0221622 A1
(43) Pub. Date: Jul. 30, 2026

(54) Lead Out Assembly and Solid-State Battery

(71) Applicant: Microvast, Inc., Stafford, TX (US)

(72) Inventors: Haojun QI, Huzhou (CN); Minshuai YIN, Huzhou (CN); Weifeng FANG, Huzhou (CN); Wenjuan Liu MATTIS, Longwood, FL (US)

(73) Assignee: Microvast, Inc., Stafford, TX (US)

(21) Appl. No.: 19/037,311

(22) Filed: Jan. 27, 2025

(51) Int. Cl. H01M 50/557; H01M 50/176; H01M 50/186; H01M 50/533; H01M 50/55

(52) U.S. Cl. CPC H01M 50/557; H01M 50/176; H01M 50/186; H01M 50/533; H01M 50/55

(57) ABSTRACT

This application provides a lead out assembly including a mounting substrate, a terminal structure, and a current collecting layer provided on the mounting substrate. The current collecting layer is used to be in contact with the battery cell. The terminal structure includes at least one external terminal, and the external terminal includes a first section and a second section that are connected to each other. The first section is provided on the mounting substrate and electrically connected to the current collecting layer, while the second section extends outside the mounting substrate. Along a thickness direction of the current collecting layer, the first section is bent relative to the current collecting layer towards the side where the mounting substrate is located. This application also provides a solid-state battery.

### TECHNICAL FIELD

This application relates to the field of battery technology, and in particular to a lead out assembly and a solid-state battery.

### BACKGROUND

In the research and development and application of solid-state batteries, bipolar stacked structures are widely regarded as an important means to improve battery energy density and performance. The battery cell of bipolar stacked structures generally includes multiple composite electrode plates, each of which includes a current collector, and a positive electrode active material layer and a negative electrode active material layer respectively provided on opposite sides of the current collector; the multiple composite electrode plates are sequentially stacked, with adjacent composite electrode plates being separated by a solid-state electrolyte layer, and the multiple composite electrode plates are combined with each solid-state electrolyte layer through a hot-pressing process to form a battery cell.

### SUMMARY

In order to ensure that each solid-state electrolyte layer can fully contact the adjacent positive electrode active material layer and negative electrode active material layer, it is generally necessary to use a pressure exceeding 300 MPa to hot-press the composite electrode plates and the solid-state electrolyte layers during the production of the battery cell. Under such great pressure, the electrode tabs of the battery cell will bear significant shear forces at their junction with the battery cell, making the electrode tabs prone to occurring problems such as warping, bulging, cracking, etc., thus affecting the reliability of the electrode tabs. Further, after the electrode tabs occur the deformation problems such as warping, bulging, etc., it is also easy to cause short circuit due to contact between the positive electrode tab and the negative electrode tab or between the electrode tabs and the current collector, thereby reducing the production yield rate of the final assembly of the battery cells into a solid-state battery, and increasing the safety risk of the solid-state battery during use.

The object of the present application is to provide a lead out assembly that can reduce the risk of occurring warping, bulging, cracking, and other problems for the external terminal during the hot-pressing process, reduce the risk of short circuit caused by the external terminal coming into contact with the current collector or other external terminals during the hot-pressing process, and improve the production yield rate and the use safety of the battery.

The present application provides a lead out assembly including a mounting substrate, a terminal structure, and a current collecting layer provided on the mounting substrate, wherein the current collecting layer is configured to be in contact with a battery cell; the terminal structure includes at least one external terminal, the external terminal includes a first section and a second section that are connected to each other, the first section is provided on the mounting substrate and electrically connected to the current collecting layer, while the second section extends outside the mounting substrate; along a thickness direction of the current collecting layer, the first section is bent relative to the current collecting layer towards the side where the mounting substrate is located.

In an achievable manner, the first section includes a bent part, and the second section is connected to the current collecting layer through the bent part; along the thickness direction, the bent part is bent relative to the current collecting layer towards the side where the mounting substrate is located.

In an achievable manner, a bending angle of the bent part relative to the current collecting layer is a, with 0°<a≤90°.

In an achievable manner, the first section further includes a first extension part, and the second section is connected to the bent part through the first extension part.

In an achievable manner, the first extension part and the second section are both sheet structures that are parallel to the mounting substrate.

In an achievable manner, the first section further includes a second extension part, and the bent part and the current collecting layer are connected by the second extension part.

In an achievable manner, the mounting substrate has a mounting surface, the current collecting layer is arranged on the mounting surface, and an insulation structure is provided between the first section and the plane where the mounting surface is located;
a bending depth of the first section relative to the current collecting layer towards the side where the mounting substrate is located is h, with h≥e*g*U_{T}+t₁; wherein e is an insulation design redundancy factor of the insulation structure, with 1≤e≤3; g is an insulation coefficient of the insulation structure; U_{T} is a nominal voltage of the entire battery cell; t₁ is a thickness of the external terminal.

In an achievable manner, at least a portion of the first section is embedded and fixed in the mounting substrate.

In an achievable manner, the mounting substrate is provided with an installation groove, at least a portion of the first section is fixedly arranged in the installation groove, while the second section and the current collecting layer are both located outside the installation groove and respectively located on opposite sides of the first section.

In an achievable manner, an insulation fixture is provided in the installation groove, and the insulation fixture is fixedly connected to the mounting substrate; at least a portion of the first section is fixedly connected to the insulation fixture.

In an achievable manner, a first insulation adhesive is provided within the insulation fixture, and at least a portion of the first section is buried between the insulation fixture and the first insulation adhesive, and the first section is fixedly adhered to the insulation fixture through the first insulation adhesive.

In an achievable manner, a second insulation layer is provided on the mounting substrate, and the second insulation layer covers the first insulation adhesive and the insulation fixture.

In an achievable manner, the first section includes a first extension part, a bent part, and a second extension part, which are connected in sequence, and along the thickness direction, the bent part is bent relative to the current collecting layer towards the side where the mounting substrate is located; the second section and the bent part are connected by the first extension part, and the bent part and the current collecting layer are connected by the second extension part; the first extension part and at least a portion of the bent part are fixedly arranged in the installation groove.

In an achievable manner, the mounting substrate has a mounting surface, the current collecting layer and the second extension part are both arranged on the mounting surface, and an insulation structure is provided between the first section and the plane where the mounting surface is located, the insulation structure includes a first insulation adhesive and a first insulation layer; the first insulation adhesive is provided in the installation groove and is located between the first extension part and the plane where the mounting surface is located, a surface of the first insulation adhesive on the side away from the mounting substrate is flush with the mounting surface; the first insulation layer is located between the current collecting layer and the mounting surface, as well as between the second extension part and the plane where the mounting surface is located.

In an achievable manner, a bending depth of the first section relative to the current collecting layer towards the side where the mounting substrate is located is h, with h≥e₁*g₁*U_{T}+e₂*g₂*U_{T}+t₁; wherein e₁ is an insulation design redundancy factor of the first insulation layer, with 1≤e1≤3; g₁ is an insulation coefficient of the first insulation layer; e₂ is an insulation design redundancy factor of the first insulation adhesive, with 1≤e₂≤3; g₂ is an insulation coefficient of the first insulation adhesive; U_{T} is a nominal voltage of the entire battery cell; t₁ is a thickness of the external terminal.

In an achievable manner, a minimum distance between the bent part and an inner wall of the installation groove is bₘᵢₙ, with bₘᵢₙ≥e₁*g₁*U_{T}+e₂*g₂*U_{T}; wherein e₁ is an insulation design redundancy factor of the first insulation layer, with 1≤e1≤3; g₁ is an insulation coefficient of the first insulation layer; e₂ is an insulation design redundancy factor of the first insulation adhesive, with 1≤e2≤3; g₂ is an insulation coefficient of the first insulation adhesive; U_{T} is a nominal voltage of the entire battery cell.

In an achievable manner, the external terminal and the current collecting layer are an integral structure.

In an achievable manner, the terminal structure includes multiple external terminals, and the multiple external terminals are arranged at intervals along a width direction of the current collecting layer.

The present application also provides a solid-state battery including a battery cell and the lead out assembly as described above, wherein the current collecting layer is in contact with the battery cell.

In an achievable manner, there are two lead out assemblies, the battery cell is located between the current collecting layers of the two lead out assemblies; the current collecting layer in one of the lead out assemblies is in contact with one side of the battery cell, while the current collecting layer in the other lead out assembly is in contact with the other side of the battery cell.

In an achievable manner, the solid-state battery further includes a sealing side plate, the sealing side plate is located between the mounting substrates of the two lead out assemblies, and the sealing side plate is arranged around a periphery of the battery cell, the sealing side plate is fixedly connected to the mounting substrates of the two lead out assemblies, and the second section of the external terminal extends outside the solid-state battery by bypassing the sealing side plate; a second insulation adhesive is filled between the sealing side plate and the battery cell.

In an achievable manner, the solid-state battery further includes an insulation film, and the insulation film is wrapped around an exterior of the mounting substrates and the sealing side plate; the second section of the external terminal extends outside the insulation film.

In an achievable manner, the battery cell includes multiple cell units sequentially stacked along the thickness direction of the current collecting layer, and each cell unit includes a positive electrode active material layer, a solid-state electrolyte layer, and a negative electrode active material layer sequentially stacked along the thickness direction;
the current collecting layer in one of the lead out assemblies is in contact with the positive electrode active material layer in one of the outermost cell units, and the current collecting layer in the other lead out assembly is in contact with the negative electrode active material layer in the other outermost cell unit.

In an achievable manner, a current collector is provided between every adjacent two cell units; in every adjacent two cell units, the adjacent positive electrode active material layer and negative electrode active material layer are respectively provided on opposite sides of a corresponding current collector, so that the adjacent positive electrode active material layer, current collector and negative electrode active material layer form a composite electrode plate.

In the lead out assembly provided in this application, by setting the first section of the external terminal as a bent structure, the first section is bent relative to the current collecting layer towards the side where the mounting substrate is located, which can reduce the shear force experienced by the first section during the hot-pressing process, thereby reducing the risk of occurring warping, bulging, cracking and other problems for the external terminal during the hot-pressing process; meanwhile, since the first section is bent relative to the current collecting layer towards the side where the mounting substrate is located, the second section is located on the side of the current collecting layer away from the battery cell. The bending depth of the first section can offset at least part of the deformation of the external terminal during the hot-pressing process, thereby reducing the risk of short circuit caused by contact between the external terminal and the current collector or other external terminals, and improving the production yield rate and the use safety of the battery.

### BRIEF DESCRIPTION OF THE DRAWINGS

FIG. 1 is a schematic cross-sectional view of the solid-state battery in the embodiment of the present application.

FIG. 2 is a partially enlarged schematic diagram of FIG. 1.

FIG. 3 is a schematic diagram of the assembly process of the battery cell and the lead out assembly in the embodiment of the present application.

FIG. 4 is a schematic diagram of the three-dimensional structure of the lead out assembly in the embodiment of the present application.

FIGS. 5A to 5E are schematic diagrams of the assembly process of the lead out assembly in the embodiment of the present application.

FIG. 6 is a partially enlarged schematic diagram of a solid-state battery in another embodiment of the present application.

FIG. 7 is a schematic diagram of the three-dimensional structure of the lead out assembly in another embodiment of the present application.

FIG. 8 is a schematic cross-sectional view of the battery cell during the hot-pressing process in the comparative example of the present application.

In the figures: 1-mounting substrate, 10-mounting surface, 101-step, 11-installation groove, 111-inner wall, 12-insulation fixture, 121-slope, 13-second insulation layer, 2-terminal structure, 20-external terminal, 21-first section, 211-first extension part, 212-bent part, 213-second extension part, 22-second section, 3-battery cell, 30-cell unit, 300-composite electrode plate, 31-positive electrode active material layer, 32-solid electrolyte layer, 33-negative electrode active material layer, 34-current collector, 4-current collecting layer, 5-insulation structure, 51-first insulation adhesive, 52-first insulation layer, 6-sealing side plate, 7-second insulation adhesive, 8-insulation film, 9-pressure plate.

### DETAILED DESCRIPTION OF THE EMBODIMENTS

The following will provide a further detailed description of the specific implementations of the present application in conjunction with the accompanying drawings and embodiments. The following embodiments are used to illustrate the present application, but are not intended to limit the scope of the present application.

The terms “first”, “second”, “third”, “fourth”, etc. (if any) in the specification and claims of the present application are only used to distinguish similar objects, and are not intended to be used to describe a specific sequence or order.

The terms “up”, “down”, “left”, “right”, “front”, “back”, “top”, “bottom” (if any) in the specification and claims of the present application are defined based on the position of the structure in the figures and the position between the structures in the figures, only for the clarity and convenience of expressing the technical solution. It should be understood that the use of these directional words should not limit the scope of protection in the present application.

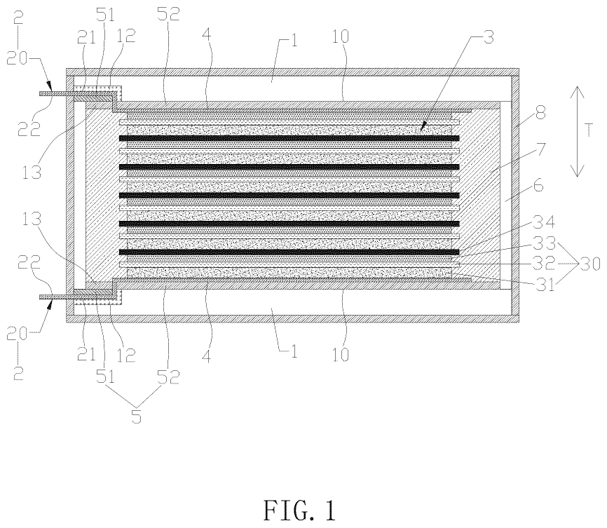

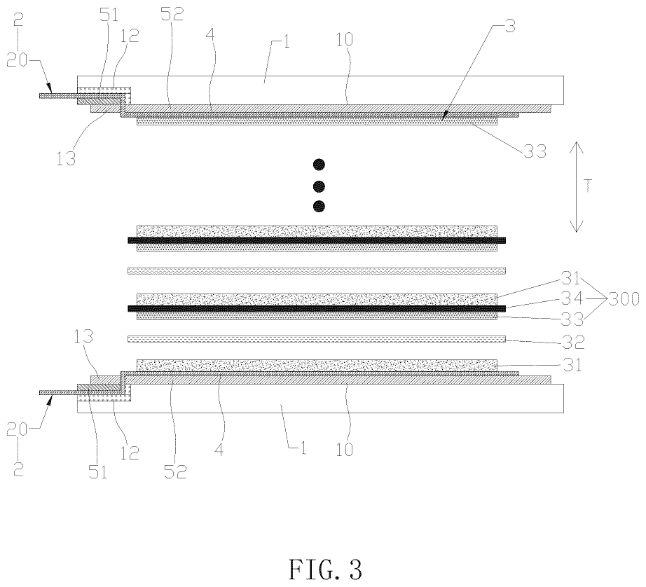

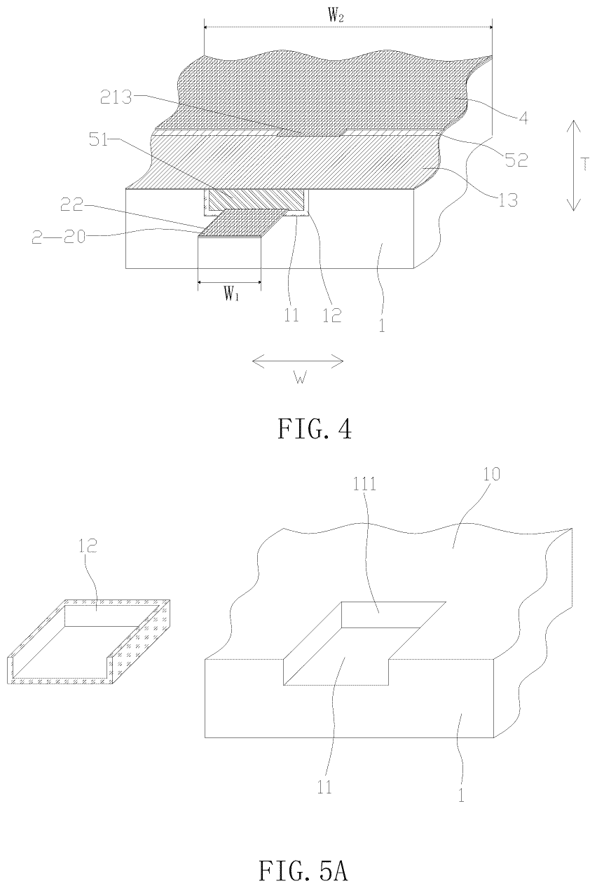

As shown in FIGS. 1 to 4, an embodiment of the present application provides a lead out assembly, which includes a mounting substrate 1, a terminal structure 2, and a current collecting layer 4 provided on the mounting substrate 1. The current collecting layer 4 is used to be in contact with the battery cell 3, such that the current collecting layer 4 is electrically connected with the battery cell 3; the battery cell 3 is located on one side of the current collecting layer 4 away from the mounting substrate 1. The terminal structure 2 includes at least one external terminal 20, and both the external terminal 20 and the current collecting layer 4 are thin sheet structures. Each external terminal 20 includes a first section 21 and a second section 22 that are connected to each other. The first section 21 is provided on the mounting substrate 1 and electrically connected to the current collecting layer 4, while the second section 22 extends outside the mounting substrate 1. The first section 21 is a bent structure; the current collecting layer 4 has a thickness direction T and a width direction W that are perpendicular to each other. Along the thickness direction T of the current collecting layer 4, the first section 21 is bent relative to the current collecting layer 4 towards the side where the mounting substrate 1 is located (i.e., the first section 21 is bent relative to the current collecting layer 4 towards the side away from the battery cell 3).

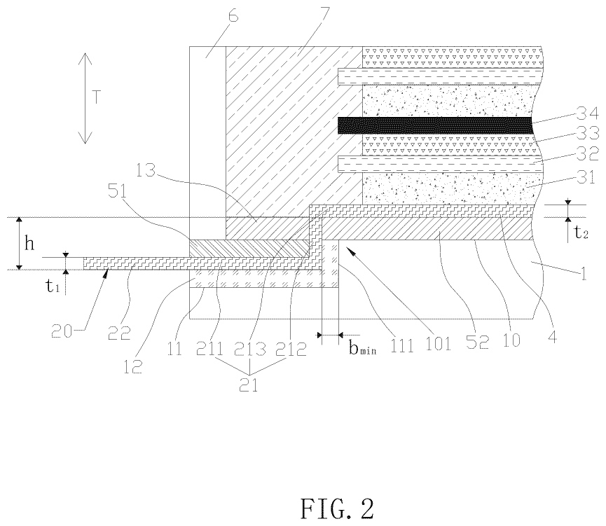

As shown in FIGS. 1 and 2, as one embodiment, along the thickness direction T, the second section 22 is located on the side of the current collecting layer 4 near the mounting substrate 1 (i.e., the second section 22 is located on the side of the current collecting layer 4 away from the battery cell 3).

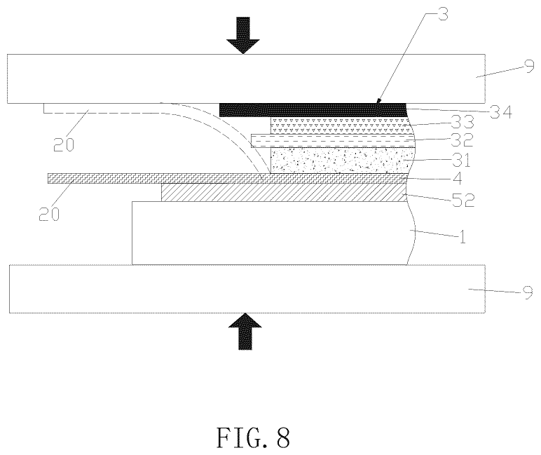

Specifically, as shown in FIG. 8, the external terminal 20 is generally a sheet structure (i.e., a flat structure). When using a hot-pressing device to hot-press the battery cell 3, the pressure plates 9 of the hot-pressing device apply pressure to the battery cell 3 from both sides. At this time, the external terminal 20 will deform towards the side close to the battery cell 3. Meanwhile, due to the large shear force that the external terminal 20 bears at its junction with the battery cell 3, the external terminal 20 is prone to occurring problems such as warping, bulging, cracking, etc., thus affecting the reliability of the external terminal 20 in subsequent use; further, after the external terminal 20 occurs the deformation problems such as warping, bulging, etc., (in FIG. 8, the dashed line represents the deformed external terminal 20), it is easy to cause short circuit due to contact between the external terminal 20 and the current collector 34 in the battery cell 3 or other external terminals 20, thereby reducing the production yield rate of the battery and increasing the safety risk of the battery during use.

However, in this embodiment, as shown in FIGS. 1 and 2, by setting the first section 21 of the external terminal 20 as a bent structure, the first section 21 is bent relative to the current collecting layer 4 towards the side where the mounting substrate 1 is located, which can reduce the shear force experienced by the first section 21 during the hot-pressing process (during the hot-pressing process, when the first section 21 is subjected to pressure towards the side close to the battery cell 3, the bending position of the first section 21 will first deform towards the side close to the battery cell 3, thereby relieving some of the pressure experienced by the first section 21 and further reducing the shear force experienced by the first section 21), thereby reducing the risk of occurring warping, bulging, cracking, and other problems for the external terminal 20 during the hot-pressing process. Meanwhile, since the first section 21 is bent relative to the current collecting layer 4 towards the side where the mounting substrate 1 is located, the second section 22 is located on the side of the current collecting layer 4 away from the battery cell 3. The bending depth h of the first section 21 can offset at least part of the deformation of the external terminal 20 during the hot-pressing process (i.e., offset the displacement of the external terminal 20 in the thickness direction T), thereby reducing the risk of short circuit caused by contact between the external terminal 20 and the current collector 34 or other external terminals 20 (due to the overall bending of the external terminal 20 towards the side where the mounting substrate 1 is located, the distance between the external terminal 20 and the current collector 34 or other external terminals 20 in the thickness direction T is increased. During the hot-pressing process, even if the external terminal 20 deforms towards the side close to the battery cell 3, it is not easy for the external terminal 20 to come into contact with the current collector 34 or other external terminals 20), thereby improving the production yield rate and the use safety of the battery.

As shown in FIGS. 1 to 3, as one embodiment, the battery cell 3 is a solid-state battery cell. The battery cell 3 includes multiple cell units 30 sequentially stacked along the thickness direction T, and the multiple cell units 30 form a series connected structure. Each cell unit 30 includes a positive electrode active material layer 31, a solid-state electrolyte layer 32, and a negative electrode active material layer 33, which are sequentially stacked along the thickness direction T.

As shown in FIGS. 1 and 2, as one embodiment, the first section 21 includes a bent part 212, and the second section 22 is connected to the current collecting layer 4 through the bent part 212. Along the thickness direction T, the bent part 212 is bent relative to the current collecting layer 4 towards the side where the mounting substrate 1 is located.

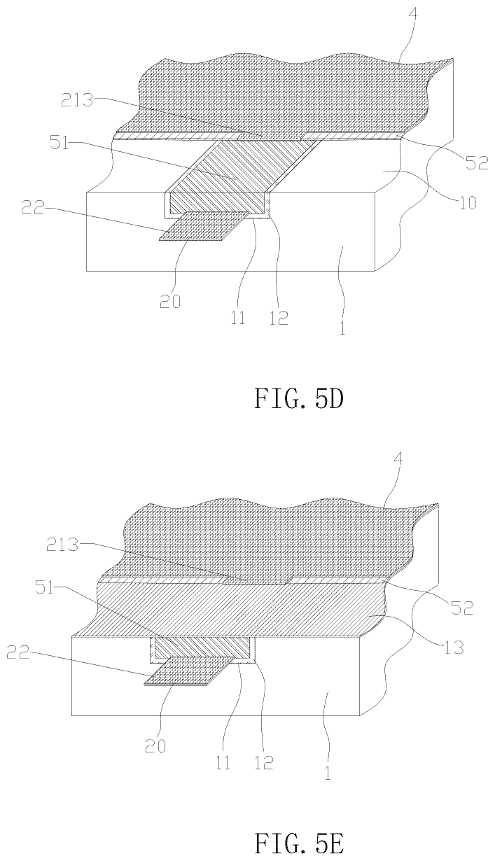

As shown in FIG. 6, as one embodiment, the bending angle of the bent part 212 relative to the current collecting layer 4 is a (the bending angle a is also the angle between the bent part 212 and the mounting substrate 1), with 0°<a≤90°.

As shown in FIGS. 1 and 2, as one embodiment, the bent part 212 is perpendicular to the current collecting layer 4, that is, a is 90°.

As shown in FIG. 6, in another embodiment, the bent part 212 is inclined relative to the current collecting layer 4, and in this case, 0°<a<90°; by setting the bent part 212 as an inclined structure, the deformation resistance of the external terminal 20 can be improved. During the hot-pressing process and the subsequent use, the external terminal 20 can withstand greater deformation and pressure, which is beneficial for improving the structural stability of the external terminal 20.

As shown in FIGS. 1 and 2, as one embodiment, the first section 21 further includes a first extension part 211, and the second section 22 and the bent part 212 are connected by the first extension part 211. The first extension part 211 and the second section 22 are both sheet structures (i.e., flat structures) that are parallel to the mounting substrate 1, and the first extension part 211 and the second section 22 are on the same plane.

As shown in FIGS. 1 and 2, as one embodiment, the first section 21 further includes a second extension part 213, and the bent part 212 and the current collecting layer 4 are connected by the second extension part 213. The second section 22, the first extension part 211, the bent part 212 and the second extension part 213 are connected in sequence, and the second section 22, the first extension part 211, the bent part 212 and the second extension part 213 are an integral structure.

As shown in FIGS. 1 and 2, as one embodiment, the second extension part 213 is a sheet structure parallel to the current collecting layer 4. The second extension part 213 and the current collecting layer 4 are on the same plane, that is, both the second extension part 213 and the current collecting layer 4 are parallel to the mounting substrate 1. The bent part 212 is bent to connect between the first extension part 211 and the second extension part 213.

As shown in FIGS. 1 and 2, as one embodiment, the bent part 212 is a flat structure. In other embodiments, the bent part 212 may also be a non-flat structure, such as a curved structure (specifically, an arc-shaped structure, etc.).

As one embodiment, the connection position between the bent part 212 and the first extension part 211 is a smooth transition, and the connection position between the bent part 212 and the second extension part 213 is a smooth transition.

As one embodiment, the external terminal 20 and the current collecting layer 4 are an integral structure. Specifically, the external terminal 20 can be formed by cutting and bending the edge of the current collecting layer 4, thereby eliminating the need for welding between the external terminal 20 and the current collecting layer 4, avoiding problems caused by virtual welding and over welding during the welding process, saving costs due to no need for welding steps, and at the same time, reducing the resistance between the external terminal 20 and the current collecting layer 4. Of course, in other embodiments, the external terminal 20 and the current collecting layer 4 can also be separate structures, which can be connected by welding.

As one embodiment, the current collecting layer 4 is a current collecting foil, which can be made of stainless steel, copper, aluminum, composite foil materials (such as copper aluminum composite foil, copper stainless steel composite foil), etc. The external terminal 20 can also be made of the above-mentioned materials.

As shown in FIG. 1 to FIG. 4, as one embodiment, the width of the external terminal 20 along the width direction W of the current collecting layer 4 is W₁, with W₁≥k₁*R*C/(n*t₁*d₁), and the unit of W₁ is mm. Specifically, k₁ is the overcurrent redundancy design coefficient of the external terminal 20, with 1<k₁≤3, and this coefficient can ensure that the external terminal 20 does not overheat or melt under continuous high current, ensuring the working safety of the external terminal 20; R is the maximum discharge rate of the battery cell 3 (i.e., the maximum discharge rate of the battery); C is the rated capacity of the battery cell 3 (i.e., the rated capacity of the battery), and the unit is Ah; n is the number of the external terminal 20 in the terminal structure 2, and n is a positive integer greater than or equal to 1; t₁ is the thickness of the external terminal 20, and the unit is mm; d₁ is the maximum current allowed to pass through the external terminal 20 per unit cross-sectional area, and the unit is A/mm².

Specifically, this embodiment can achieve appropriate redundancy design on the overcurrent performance of the external terminal 20 by providing appropriate redundancy design for the width W₁ of the external terminal 20 (i.e., introducing a coefficient k1 in the above formula), so that the external terminal 20 can meet the requirements of high rate charging and discharging, thereby avoiding overheating, melting and other problems during operation and ensuring the use safety of the battery.

As shown in FIGS. 1 to 4, as one embodiment, the terminal structure 2 includes one external terminal 20, wherein n is 1.

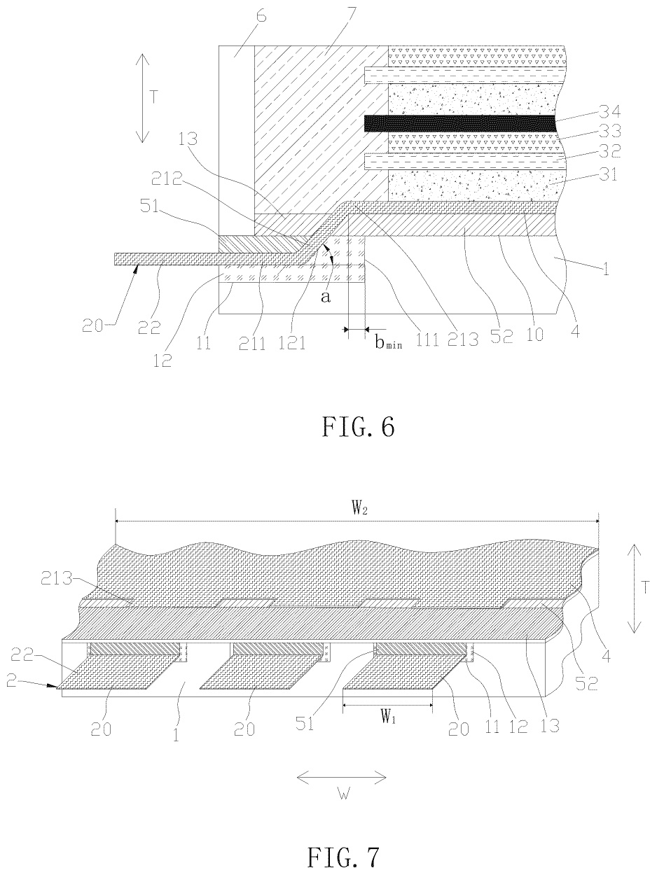

As shown in FIG. 7, as another embodiment, the terminal structure 2 includes multiple external terminals 20, i.e., n≥2; the multiple external terminals 20 are arranged at intervals along the width direction W of the current collecting layer 4, and the multiple external terminals 20 are all connected to the current collecting layer 4. Specifically, the multiple external terminals 20 are connected to different positions of the current collecting layer 4.

Specifically, by setting multiple external terminals 20, the multiple external terminals 20 can act as shunts to avoid current concentration on a single external terminal 20, thereby further avoiding overheating, melting, and other problems that the external terminal 20 may occur during high rate charging and discharging, ensuring the use safety of the battery. Meanwhile, by setting multiple external terminals 20, the thickness of the external terminals 20 can be significantly reduced under the same overcurrent capacity, thereby reducing the thickness of the current collecting layer 4 (the thickness of the current collecting layer 4 is generally equal to that of the external terminal 20), thereby reducing the weight of the battery and improving the energy density of the battery.

As one embodiment, the terminal structure 2 includes at least three external terminals 20, i.e., n≥3; alternatively, the terminal structure 2 includes at least five external terminals 20, i.e., n≥5.

As shown in FIGS. 1 to 4, as one embodiment, the thickness of the current collecting layer 4 is t₂, with t₂≥k₂*R*C/(W₂*d₂), and the unit of t₂ is mm. Specifically, k₂ is the overcurrent redundancy design coefficient of the current collecting layer 4, with 1<k₂≤3, and this coefficient can ensure that the current collecting layer 4 does not overheat or melt under continuous high current, ensuring the working safety of the current collecting layer 4; W₂ is the width of the current collecting layer 4, and the unit is mm; d₂ is the maximum current allowed to pass through the current collecting layer 4 per unit cross-sectional area, and the unit is A/mm².

Specifically, this embodiment provides appropriate redundancy design for the thickness t₂ of the current collecting layer 4 (i.e., introducing a coefficient k₂ in the above formula), in order to achieve appropriate redundancy design on the overcurrent performance of the current collecting layer 4, so that the current collecting layer 4 can meet the requirements of high rate charging and discharging, thereby avoiding overheating and other problems during operation, ensuring the use safety of the battery, and avoiding the impact of excessive thickness of the current collecting layer 4 on the energy density of the battery.

As shown in FIGS. 1 to 4, as one embodiment, at least a portion of the first section 21 is embedded and fixed in the mounting substrate 1, and the first section 21 is insulated from the mounting substrate 1 (generally, the mounting substrate 1 is made of conductive material, such as metal. Of course, the mounting substrate 1 can also be made of insulation material). This setting can further reduce the risk of occurring warping, bulging, wrinkling, cracking, and other problems for the external terminal 20 during the hot-pressing process; meanwhile, since the first section 21 is embedded and fixed in the mounting substrate 1, the mounting substrate 1 can provide protection for the external terminal 20 and enhance the tensile strength and sealing performance of the external terminal 20 during subsequent use (external moisture and other substances cannot easily enter the battery through the external terminal 20). Moreover, the external terminal 20 is integrated with the mounting substrate 1, which is conducive to the transportation and transfer of the lead out assembly during the assembling process.

As shown in FIGS. 1 to 4, as one embodiment, the mounting substrate 1 is provided with an installation groove 11, and at least a portion of the first section 21 is fixedly arranged in the installation groove 11 (i.e., at least a portion of the first section 21 is embedded in the installation groove 11), so that the first section 21 is embedded and fixed in the mounting substrate 1, while the second section 22 and the current collecting layer 4 are both located outside the installation groove 11, and the second section 22 and the current collecting layer 4 are respectively located on opposite sides of the first section 21.

Specifically, the installation groove 11 is provided at a side position (i.e., an edge position) of the mounting substrate 1, and the installation groove 11 penetrates a side wall of the mounting substrate 1, so that the second section 22 extends outside the installation groove 11 through a side opening of the installation groove 11. In this embodiment, the number of the installation groove 11 is one, and the installation groove 11 is used to arrange one external terminal 20. As shown in FIG. 7, when there are multiple external terminals 20, multiple installation grooves 11 need to be provided on the mounting substrate 1, and the multiple installation grooves 11 correspond one-to-one with the multiple external terminals 20.

As shown in FIGS. 1 to 4, as one embodiment, the first extension part 211 and at least a portion of the bent part 212 are fixedly arranged in the installation groove 11, and the second extension part 213 is located outside the installation groove 11. Specifically, in this embodiment, one end of the bent part 212 near the second extension part 213 is located outside the installation groove 11, and one end of the bent part 212 near the first extension part 211 extends into the installation groove 11, that is, a portion of the bent part 212 is fixedly arranged in the installation groove 11.

As shown in FIGS. 1 to 4, as one embodiment, an insulation fixture 12 is provided in the installation groove 11, and the insulation fixture 12 is fixedly connected to the mounting substrate 1. At least a portion of the first section 21 is located within the insulation fixture 12, and at least a portion of the first section 21 is fixedly connected to the insulation fixture 12. A first insulation adhesive 51 is provided within the insulation fixture 12, and at least a portion of the first section 21 is buried between the insulation fixture 12 and the first insulation adhesive 51. The first section 21 is fixedly adhered to the insulation fixture 12 through the first insulation adhesive 51, so that the first section 21 is embedded and fixed in the mounting substrate 1, and the first section 21 is insulated from the mounting substrate 1. The first insulation adhesive 51 can be provided within the insulation fixture 12 through a pouring process of insulation glue. During the pouring process, attention should be paid to prevent the generation of bubbles to ensure the sealing and insulation properties of the first insulation adhesive 51.

Specifically, in this embodiment, the first extension part 211 and a portion of the bent part 212 are located within the insulation fixture 12 and buried between the insulation fixture 12 and the first insulation adhesive 51. The first extension part 211 and the bent part 212 are in contact with the inner wall of the insulation fixture 12; the second extension part 213 is located outside the insulation fixture 12. The insulation fixture 12 is a drawer shaped structure similar in shape to the installation groove 11, and the second section 22 extends outside the insulation fixture 12 through a side opening of the insulation fixture 12. As shown in FIG. 6, in another embodiment, when the bent part 212 is an inclined structure, the insulation fixture 12 is provided with a slope 121 that is in contact with the bent part 212. The slope 121 can support the bent part 212, thereby improving the adhesion tightness between the external terminal 20 and the insulation fixture 12, and enhancing the pressure bearing capacity of the external terminal 20.

As shown in FIGS. 1 to 4, as one embodiment, the height of the insulation fixture 12 is equal to the depth of the installation groove 11, so that the end face of the insulation fixture 12 (i.e., the end face on the side of the insulation fixture 12 away from the mounting substrate 1 along the thickness direction T) is flush with the mounting surface 10 of the mounting substrate 1; meanwhile, the surface of the first insulation adhesive 51 (i.e., the surface on the side of the first insulation adhesive 51 away from the mounting substrate 1 along the thickness direction T) is flush with the mounting surface 10 of the mounting substrate 1.

As one embodiment, the insulation fixture 12 is fixedly adhered to the mounting substrate 1 by bonding adhesive (not shown), that is, the insulation fixture 12 is fixedly adhered to the inner wall of the installation groove 11 by bonding adhesive. The materials of the insulation fixture 12 can be high temperature and high voltage resistant materials, such as PTFE (polytetrafluoroethylene), PVC (polyvinyl chloride), PP (polypropylene), PET (polyethylene terephthalate), etc. The mounting substrate 1 can be made of high hardness materials such as stainless steel and aluminum alloy. The materials of the first insulation adhesive 51 and the bonding adhesive can be high temperature and high voltage resistant materials, such as PTFE adhesive, PVC adhesive, PP adhesive, etc.

As one embodiment, both the inner and outer surfaces of the insulation fixture 12 are rough structures, thereby improving the contact area and adhesion performance between the bonding adhesive and the outer surface of the insulation fixture 12, and between the first insulation adhesive 51 and the inner surface of the insulation fixture 12.

As shown in FIGS. 1 to 5E, as one embodiment, the mounting substrate 1 has a mounting surface 10, and the mounting surface 10 is located on the side of the mounting substrate 1 facing the battery cell 3. The installation groove 11 is formed by recessing from the mounting surface 10 towards a direction away from the battery cell 3. The current collecting layer 4 and the second extension part 213 are both arranged on the mounting surface 10.

An insulation structure 5 is provided between the first section 21 and the plane where the mounting surface 10 is located. The bending depth of the first section 21 relative to the current collecting layer 4 towards the side where the mounting substrate 1 is located (i.e., the bending depth of the bent part 212 relative to the current collecting layer 4 towards the side where the mounting substrate 1 is located) is h, with h≥e*g*U_{T}+t₁, and the unit of h is mm. Specifically, e is the insulation design redundancy factor of the insulation structure 5, with 1≤e≤3, and this coefficient can ensure the insulation performance between the first section 21 and the mounting substrate 1; g is the insulation coefficient of the insulation structure 5, that is, the thickness required for the insulation structure 5 to achieve the predetermined insulation effect at a unit voltage, and the unit of g is mm/V; U_{T} is the nominal voltage of the entire battery cell 3, and the unit is V; t₁ is the thickness of the external terminal 20, and the unit is mm.

Specifically, U_{T}=U*s; U is the nominal voltage of a single cell unit 30, and the unit is V; s is the number of the cell units 30 in the battery cell 3.

As shown in FIGS. 1 to 5E, as one embodiment, the insulation structure 5 includes a first insulation adhesive 51 and a first insulation layer 52; the first insulation adhesive 51 is provided in the installation groove 11, the first insulation adhesive 51 is located between the first extension part 211 and the plane where the mounting surface 10 is located, the surface of the first insulation adhesive 51 on the side away from the mounting substrate 1 is flush with the mounting surface 10; the first insulation layer 52 is located between the current collecting layer 4 and the mounting surface 10, as well as between the second extension part 213 and the plane where the mounting surface 10 is located (i.e., a portion of the first insulation layer 52 is sandwiched between the current collecting layer 4 and the mounting surface 10, and another portion is sandwiched between the second extension part 213 and the plane where the mounting surface 10 is located), and a side surface of the first insulation layer 52 is flush with an inner wall of the insulation fixture 12 (specifically, the inner wall of the insulation fixture 12 on the side near the current collecting layer 4).

In this case, h≥e₁*g₁*U_{T}+e₂*g₂*U_{T}+t₁, wherein e₁ is the insulation design redundancy factor of the first insulation layer 52, with 1≤e₁≤3, and this coefficient can ensure the insulation performance between the current collecting layer 4 and the mounting substrate 1, and between the second extension part 213 and the mounting substrate 1; g₁ is the insulation coefficient of the first insulation layer 52, that is, the thickness required for the first insulation layer 52 to achieve the predetermined insulation effect at a unit voltage, and the unit of g₁ is mm/V; e₂ is the insulation design redundancy factor of the first insulation adhesive 51, with 1≤e₂≤3, and this coefficient can ensure the insulation performance between the first extension part 211 and the mounting substrate 1; g₂ is the insulation coefficient of the first insulation adhesive 51, that is, the thickness required for the first insulation adhesive 51 to achieve the predetermined insulation effect at a unit voltage, and the unit of g₂ is mm/V; U_{T} is the nominal voltage of the entire battery cell 3, and the unit is V, t₁ is the thickness of the external terminal 20, and the unit is mm.

As one embodiment, the materials of the first insulation layer 52 can be high temperature and high voltage resistant materials, such as PTFE, PVC, PP, PET, etc. The two sides of the first insulation layer 52 are provided with backing adhesive (not shown), and the two sides of the first insulation layer 52 are fixedly adhered to the current collecting layer 4 and the mounting substrate 1, respectively. The materials of the backing adhesive can be high temperature and high voltage resistant materials, such as PTFE adhesive, PVC adhesive, PP adhesive, etc.

As shown in FIGS. 1, 2, and 5A, as one embodiment, the minimum distance between the bent part 212 and an inner wall 111 of the installation groove 11 (specifically referring to the inner wall of the installation groove 11 on the side near the current collecting layer 4) is bₘᵢₙ, with bₘᵢₙ≥e*g* U_{T}, i.e., bₘᵢₙ≥e₁*g₁*U_{T}+e₂*g₂*U_{T}. This setting can ensure the insulation performance between the bent part 212 and the mounting substrate 1. It should be noted that, as shown in FIG. 2, when the bent part 212 is perpendicular to the current collecting layer 4, the spacing between various positions of the bent part 212 and the inner wall 111 of the installation groove 11 is equal, and bₘᵢₙ is the distance between any position of the bent part 212 and the inner wall 111 of the installation groove 11; as shown in FIG. 6, when the bent part 212 is an inclined structure, bₘᵢₙ is the distance between the end of the bent part 212 near the second extension part 213 and the inner wall 111 of the installation groove 11.

As shown in FIGS. 1 and 2, as one embodiment, a step 101 is formed on the mounting substrate 1, and the step 101 is located between the installation groove 11 and the current collecting layer 4. The bent part 212 and the second extension part 213 both rest on the step 101.

As shown in FIGS. 1 to 5E, as one embodiment, a second insulation layer 13 is provided on the mounting substrate 1 (specifically, the second insulation layer 13 is provided on the mounting surface 10, and the second insulation layer 13 and the first insulation layer 52 are located on opposite sides of the bent part 212, with a portion of the bent part 212 being sandwiched between the second insulation layer 13 and the first insulation layer 52). The second insulation layer 13 covers the first insulation adhesive 51 and the insulation fixture 12. The second insulation layer 13 can further improve the insulation performance between the mounting substrate 1 and the external terminal 20 and the current collecting layer 4, avoiding the problem of short circuit during stacking and installation. In this embodiment, backing adhesive (not shown) is provided on the side of the second insulation layer 13 facing the mounting substrate 1, and the second insulation layer 13 is fixedly adhered to the mounting substrate 1, the first insulation adhesive 51 and the insulation fixture 12 through the backing adhesive. The materials of the second insulation layer 13 can be high temperature and high voltage resistant materials, such as PTFE, PVC, PP, PET, etc.

As one embodiment, the thickness of the second insulation layer 13 is equal to the thickness of the first insulation layer 52.

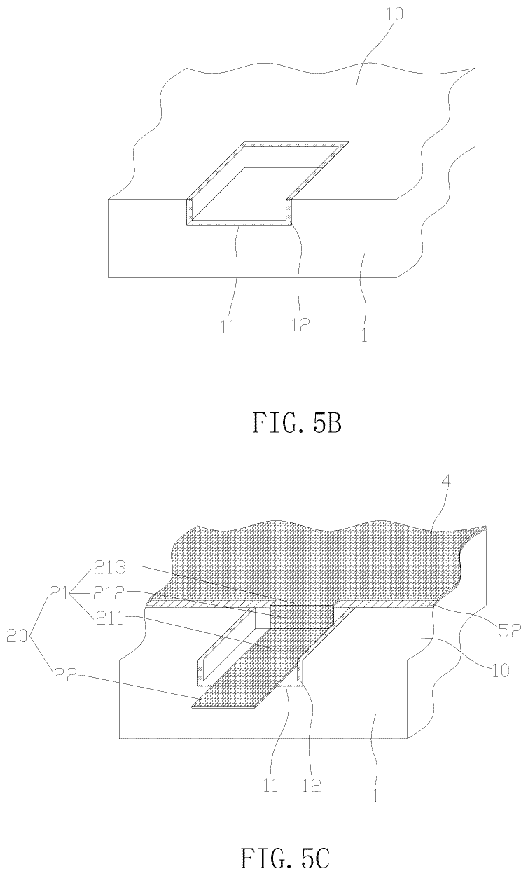

As shown in FIGS. 5A to 5E, as one embodiment, the assembling steps of the lead out assembly can be as follows:
(1) As shown in FIG. 5A, the mounting substrate 1 and the insulation fixture 12 are provided, wherein an edge position of the mounting substrate 1 is provided with the installation groove 11, and the shape and size of the installation groove 11 match the shape and size of the insulation fixture 12; the insulation fixture 12 has a drawer shaped structure, and both the inner and outer surfaces of the insulation fixture 12 are rough structures.
(2) As shown in FIG. 5B, bonding adhesive is applied on the inner wall of the installation groove 11 and/or the outer surface of the insulation fixture 12, and then the insulation fixture 12 is installed in the installation groove 11, so that the insulation fixture 12 is fixedly adhered to the mounting substrate 1 through the bonding adhesive.
(3) As shown in FIG. 5C, backing adhesive is applied on both sides of the first insulation layer 52, and then the first insulation layer 52 is placed on the mounting surface 10 of the mounting substrate 1, so that the first insulation layer 52 is fixedly adhered to the mounting substrate 1 through the backing adhesive, and a side surface of the first insulation layer 52 is flush with an inner wall of the insulation fixture 12 (specifically, the inner wall of the insulation fixture 12 on the side near the current collecting layer 4).

The current collecting layer 4 and the external terminal 20 are simultaneously obtained by cutting a collector foil, wherein the current collecting layer 4 and the external terminal 20 are an integral structure. The external terminal 20 is bent to obtain the bent external terminal 20.

The current collecting layer 4 is attached to the first insulation layer 52, and the current collecting layer 4 is fixedly adhered to the first insulation layer 52 through the backing adhesive. Meanwhile, the first section 21 of the external terminal 20 extends into the insulation fixture 12 and is adhered to the inner wall of the insulation fixture 12; the second section 22 of the external terminal 20 extends outside the insulation fixture 12.
(4) As shown in FIG. 5D, insulation glue is poured into the insulation fixture 12. After the insulation glue solidifies, the first insulation adhesive 51 is obtained, and a portion of the first section 21 is buried between the insulation fixture 12 and the first insulation adhesive 51. During the pouring process, the amount of pouring the insulation glue is controlled, so that the surface of the first insulation adhesive 51 on the side away from the mounting substrate 1 is flush with the mounting surface 10 of the mounting substrate 1; meanwhile, during the pouring process, attention should be paid to prevent the generation of bubbles to ensure the sealing and insulation properties of the first insulation adhesive 51.
(5) As shown in FIG. 5E, backing adhesive is applied on one side of the second insulation layer 13, and the second insulation layer 13 is placed on the mounting substrate 1. The second insulation layer 13 covers the first insulation adhesive 51 and the insulation fixture 12, and the second insulation layer 13 is fixedly adhered to the mounting substrate 1, the first insulation adhesive 51 and the insulation fixture 12 through the backing adhesive. The second insulation layer 13 and the first insulation layer 52 are arranged close to each other, to sandwich a portion of the bent part 212 (i.e., the upper end of the bent part 212) between the second insulation layer 13 and the first insulation layer 52.

Through the above steps, the assembling of the lead out assembly is completed, and the various parts of the lead out assembly are connected as a whole, thereby facilitating subsequent transportation, transfer, and assembling.

As shown in FIGS. 1 to 3, the embodiment of the present application also provides a solid-state battery, particularly an all solid-state battery, including a battery cell 3 and the lead out assembly as described above. The battery cell 3 is located on the side of the current collecting layer 4 away from the mounting substrate 1, that is, the current collecting layer 4 is located between the battery cell 3 and the mounting substrate 1, and the current collecting layer 4 is in contact with the battery cell 3 to electrically connect the current collecting layer 4 to the battery cell 3.

As shown in FIGS. 1 to 3, as one embodiment, there are two lead out assemblies, and the battery cell 3 is located between the current collecting layers 4 of the two lead out assemblies; the current collecting layer 4 in one of the lead out assemblies is in contact with one side of the battery cell 3, while the current collecting layer 4 in the other lead out assembly is in contact with the other side of the battery cell 3. The external terminal 20 in one of the lead out assemblies serves as a positive tab of the battery, while the external terminal 20 in the other lead out assembly serves as a negative tab of the battery. The positive and negative tabs are used for electrical connection with an external device (not shown).

As shown in FIGS. 1 to 3, as one embodiment, the solid-state battery further includes a sealing side plate 6, and the sealing side plate 6 is located between the mounting substrates 1 of the two lead out assemblies; the sealing side plate 6 is a circular structure (it can be a single circular structure or a circular structure composed of multiple small pieces), and the sealing side plate 6 is arranged around the periphery of the battery cell 3. The sealing side plate 6 is fixedly connected to the mounting substrates 1 of the two lead out assemblies. A second insulation adhesive 7 is filled between the sealing side plate 6 and the battery cell 3 to improve the sealing and insulation performance of the battery cell 3 (for ensuring insulation between the sealing side plate 6 and the battery cell 3). The second section 22 of the external terminal 20 extends outside the solid-state battery by bypassing the sealing side plate 6 through the installation groove 11; due to the bending design of the external terminal 20 and the extension out of the external terminal 20 through the installation groove 11 of the mounting substrate 1, the external terminal 20 can avoid the sealing side plate 6, so that there is no need to open a hole on the sealing side plate 6 for the external terminal 20 to pass through (if the external terminal 20 is a non-bending structure, it needs to pass directly through the sealing side plate 6, and a hole for the external terminal 20 to pass through needs to be opened on the sealing side plate 6), thereby ensuring the sealing performance of the sealing side plate 6 and reducing assembling difficulty.

Specifically, the sealing side plate 6 can be made of high hardness materials such as stainless steel and aluminum alloy; the sealing side plate 6 and the mounting substrate 1 can be fixed by welding to form a sealing structure for isolating external air, moisture, etc. The second insulation adhesive 7 can be filled between the sealing side plate 6 and the battery cell 3 through a pouring process of insulation glue. The materials of the second insulation adhesive 7 can be high temperature and high voltage resistant materials, such as PTFE adhesive, PVC adhesive, PP adhesive, etc. The second insulation adhesive 7 adopts anhydrous adhesive, and the moisture content in the second insulation adhesive 7 is less than or equal to 100 ppm to ensure the insulation performance of the second insulation adhesive 7.

As shown in FIG. 1, as one embodiment, the solid-state battery further includes an insulation film 8, and the insulation film 8 is wrapped around an exterior of the two mounting substrates 1 and the sealing side plate 6; the second section 22 of the external terminal 20 extends outside the insulation film 8. The insulation film 8 can provide insulation protection between the external terminal 20 and the mounting substrate 1, preventing short circuit between the external terminal 20 and the mounting substrate 1. The materials of the insulation film 8 can be high temperature and high voltage resistant materials, such as PTFE, PVC, PP, PET, etc.

As shown in FIGS. 1 to 3, as one embodiment, the battery cell 3 is a solid-state battery cell. The battery cell 3 includes multiple cell units 30 sequentially stacked along the thickness direction T, and the multiple cell units 30 form a series connected structure. Each cell unit 30 includes a positive electrode active material layer 31, a solid-state electrolyte layer 32, and a negative electrode active material layer 33, which are sequentially stacked along the thickness direction T. The current collecting layer 4 in one of the lead out assemblies is in contact with the positive electrode active material layer 31 of one outermost cell unit 30, and the current collecting layer 4 in the other lead out assembly is in contact with the negative electrode active material layer 33 of another outermost cell unit 30.

As shown in FIGS. 1 to 3, as one embodiment, a current collector 34 is provided between every adjacent two cell units 30. In every adjacent two cell units 30, the adjacent positive electrode active material layer 31 and negative electrode active material layer 33 are respectively provided on opposite sides of a corresponding current collector 34, so that the adjacent positive electrode active material layer 31, current collector 34 and negative electrode active material layer 33 form a composite electrode plate 300. That is, in every adjacent two cell units 30, the positive electrode active material layer 31 of one cell unit 30 and the negative electrode active material layer 33 of the other cell unit 30 share one current collector 34, that is, the composite electrode plate 300 includes a current collector 34, and a positive electrode active material layer 31 and a negative electrode active material layer 33 respectively provided on opposite sides of the current collector 34.

As one embodiment, the current collector 34 is a current collecting foil, which can be made of stainless steel, copper, aluminum, composite foil materials (such as copper aluminum composite foil, copper stainless steel composite foil), etc.

As one embodiment, the positive electrode active material layer 31 includes an active material, a conductive agent, a binder, and a solid-state electrolyte. Specifically, the active material includes lithium containing layered oxide, lithium containing phosphate compound, etc., such as ternary materials LiCo₈Ni₁Mn₁O₂, LiFePO₄, etc.; the conductive agent is a highly conductive material, such as conductive carbon black, carbon nanotubes, carbon nanorods, etc.; the binder is a material with adhesive properties, such as PVDF (polyvinylidene fluoride), SBR (styrene butadiene rubber), NBR (nitrile rubber), etc.; the solid-state electrolyte is a material with high ionic conductivity, such as oxides, sulfides, etc.

As one embodiment, the negative electrode active material layer 33 can be made of graphite-based materials, silicon-based materials, etc.

As shown in FIGS. 1 to 3, as one embodiment, the assembling steps of the solid-state battery can be as follows:
(1) After the assembling of the lead out assembly is completed, the composite electrode plates 300 and the solid-state electrolyte layers 32 are stacked on the current collecting layer 4 of the lead out assembly. The stacking order is: positive electrode active material layer 31, solid-state electrolyte layer 32, composite electrode plate 300, solid-state electrolyte layer 32, composite electrode plate 300, . . . , solid-state electrolyte layer 32, composite electrode plate 300, solid-state electrolyte layer 32, negative electrode active material layer 33, to form a battery cell 3; after stacking, another lead out assembly is stacked on the battery cell 3, so that the current collecting layer 4 in the other lead out assembly is in contact with the battery cell 3. During the stacking process, each layer needs to undergo a hot-pressing treatment to ensure that each solid-state electrolyte layer 32 is in full contact with the adjacent positive electrode active material layer 31 and negative electrode active material layer 33.

By directly stacking the composite electrode plates 300 and the solid-state electrolyte layers 32 in situ on the lead out assembly, the parallelism between the composite electrode plates 300 and the solid-state electrolyte layers 32 can be ensured during the stacking process, reducing the occurrence of short circuit and minimizing the occurrence of defective products during transportation, thereby improving production yield rate.
(2) Insulation glue is poured at the periphery of the battery cell 3, and after the insulation glue solidifies, it forms the second insulation glue 7. Then, the sealing side plate 6 is installed on the outside of the second insulation adhesive 7, and the sealing side plate 6 is fixedly connected to the mounting substrates 1 on both sides by welding.
(3) A layer of insulation film 8 is wrapped around an exterior of the sealing side plate 6 and the mounting substrates 1 to obtain a solid-state battery.

The above are only the specific embodiments of the present application, but the scope of protection of the present application is not limited to this. Any technical personnel familiar with this technical field who can easily think of changes or replacements within the scope of technology disclosed in the present application should be covered within the scope of protection of the present application. Therefore, the protection scope of the present application should be based on the protection scope of the claims.

1. A lead out assembly comprising a mounting substrate, a terminal structure, and a current collecting layer provided on the mounting substrate, wherein the current collecting layer is configured to be in contact with a battery cell; the terminal structure comprises at least one external terminal, the external terminal comprises a first section and a second section that are connected to each other, the first section is provided on the mounting substrate and electrically connected to the current collecting layer, while the second section extends outside the mounting substrate; along a thickness direction of the current collecting layer,, the first section is bent relative to the current collecting layer towards the side where the mounting substrate is located.

2. The lead out assembly as claimed in claim 1, wherein the first section comprises a bent part, and the second section is connected to the current collecting layer through the bent part; along the thickness direction, the bent part is bent relative to the current collecting layer towards the side where the mounting substrate is located.

3. The lead out assembly as claimed in claim 2, wherein a bending angle of the bent part relative to the current collecting layer is a, with 0°<a≤90°.

4. The lead out assembly as claimed in claim 2, wherein the first section further comprises a first extension part, and the second section is connected to the bent part through the first extension part, the first extension part and the second section are both sheet structures that are parallel to the mounting substrate, the first section further comprises a second extension part, and the bent part and the current collecting laver are connected by the second extension part.

5-6. (canceled)

7. The lead out assembly as claimed in claim 1, wherein the mounting substrate has a mounting surface, the current collecting layer is arranged on the mounting surface, and an insulation structure is provided between the first section and the plane where the mounting surface is located;
a bending depth of the first section relative to the current collecting layer towards the side where the mounting substrate is located is h, with h≥e*g*U_{T}+t₁; wherein e is an insulation design redundancy factor of the insulation structure, with 1≤e≤3; g is an insulation coefficient of the insulation structure; U_{T} is a nominal voltage of the entire battery cell; t₁ is a thickness of the external terminal.

8. The lead out assembly as claimed in claim 1, wherein at least a portion of the first section is embedded and fixed in the mounting substrate.

9. The lead out assembly as claimed in claim 8, wherein the mounting substrate is provided with an installation groove, at least a portion of the first section is fixedly arranged in the installation groove, while the second section and the current collecting layer are both located outside the installation groove and respectively located on opposite sides of the first section.

10. The lead out assembly as claimed in claim 9, wherein an insulation fixture is provided in the installation groove, and the insulation fixture is fixedly connected to the mounting substrate; at least a portion of the first section is fixedly connected to the insulation fixture.

11. The lead out assembly as claimed in claim 10, wherein a first insulation adhesive is provided within the insulation fixture, and at least a portion of the first section is buried between the insulation fixture and the first insulation adhesive, and the first section is fixedly adhered to the insulation fixture through the first insulation adhesive, a second insulation laver is provided on the mounting substrate, and the second insulation layer covers the first insulation adhesive and the insulation fixture.

12. (canceled)

13. The lead out assembly as claimed in claim 9, wherein the first section comprises a first extension part, a bent part, and a second extension part, which are connected in sequence, and along the thickness direction, the bent part is bent relative to the current collecting layer towards the side where the mounting substrate is located; the second section and the bent part are connected by the first extension part, and the bent part and the current collecting layer are connected by the second extension part; the first extension part and at least a portion of the bent part are fixedly arranged in the installation groove.

14. The lead out assembly as claimed in claim 13, wherein the mounting substrate has a mounting surface, the current collecting layer and the second extension part are both arranged on the mounting surface, and an insulation structure is provided between the first section and the plane where the mounting surface is located, the insulation structure comprises a first insulation adhesive and a first insulation layer; the first insulation adhesive is provided in the installation groove and is located between the first extension part and the plane where the mounting surface is located, a surface of the first insulation adhesive on the side away from the mounting substrate is flush with the mounting surface; the first insulation layer is located between the current collecting layer and the mounting surface, as well as between the second extension part and the plane where the mounting surface is located.

15. The lead out assembly as claimed in claim 14, wherein a bending depth of the first section relative to the current collecting layer towards the side where the mounting substrate is located is h, with h≥e₁*g₁*U_{T}+e₂*g₂*U_{T}+t₁, wherein e₁ is an insulation design redundancy factor of the first insulation layer, with 1≤e1≤3, g₁ is an insulation coefficient of the first insulation layer; e₂ is an insulation design redundancy factor of the first insulation adhesive, with 1≤e₂≤3; g₂ is an insulation coefficient of the first insulation adhesive; U_{T} is a nominal voltage of the entire battery cell; t₁ is a thickness of the external terminal.

16. The lead out assembly as claimed in claim 14, wherein a minimum distance between the bent part and an inner wall of the installation groove is bₘᵢₙ, with bₘᵢₙ≥e₁*g₁*U_{T}+e₂*g₂*U_{T}; wherein e₁ is an insulation design redundancy factor of the first insulation layer, with 1≤e1≤3; g₁ is an insulation coefficient of the first insulation layer; e₂ is an insulation design redundancy factor of the first insulation adhesive, with 1≤e2≤3; g₂ is an insulation coefficient of the first insulation adhesive; U_{T} is a nominal voltage of the entire battery cell.

17. The lead out assembly as claimed in claim 1, wherein the external terminal and the current collecting layer are an integral structure.

18. The lead out assembly as claimed in claim 1, wherein the terminal structure comprises multiple external terminals, and the multiple external terminals are arranged at intervals along a width direction of the current collecting layer.

19. A solid-state battery comprising a battery cell and the lead out assembly as claimed in claim 1, wherein the current collecting layer is in contact with the battery cell.

20. The solid-state battery as claimed in claim 19, wherein there are two lead out assemblies, the battery cell is located between the current collecting layers of the two lead out assemblies; the current collecting layer in one of the lead out assemblies is in contact with one side of the battery cell, while the current collecting layer in the other lead out assembly is in contact with the other side of the battery cell.

21. The solid-state battery according to claim 20, wherein the solid-state battery further comprises a sealing side plate, the sealing side plate is located between the mounting substrates of the two lead out assemblies, and the sealing side plate is arranged around a periphery of the battery cell, the sealing side plate is fixedly connected to the mounting substrates of the two lead out assemblies, and the second section of the external terminal extends outside the solid-state battery by bypassing the sealing side plate; a second insulation adhesive is filled between the sealing side plate and the battery cell, the solid-state battery further comprises an insulation film, and the insulation film is wrapped around an exterior of the mounting substrates and the sealing side plate; the second section of the external terminal extends outside the insulation film.

22. (canceled)

23. The solid-state battery as claimed in claim 20, wherein the battery cell comprises multiple cell units sequentially stacked along the thickness direction of the current collecting layer, and each cell unit comprises a positive electrode active material layer, a solid-state electrolyte layer, and a negative electrode active material layer sequentially stacked along the thickness direction;
the current collecting layer in one of the lead out assemblies is in contact with the positive electrode active material layer in one of the outermost cell units, and the current collecting layer in the other lead out assembly is in contact with the negative electrode active material layer in the other outermost cell unit.

24. The solid-state battery as claimed in claim 23, wherein a current collector is provided between every adjacent two cell units; in every adjacent two cell units, the adjacent positive electrode active material layer and negative electrode active material layer are respectively provided on opposite sides of a corresponding current collector, so that the adjacent positive electrode active material layer, current collector and negative electrode active material layer form a composite electrode plate.
